(19) United States
(12) Patent Application Publication
(10) Pub. No.: US 2013/0238841 A1
(43) Pub. Date: Sep. 12, 2013

(54) DATA PROCESSING DEVICE AND METHOD FOR PREVENTING DATA LOSS THEREOF

(71) Applicant: JINHYUN KIM, Yongin-Si (KR)

(72) Inventor: JINHYUN KIM, Yongin-Si (KR)

(21) Appl. No.: 13/761,193

(22) Filed: Feb. 7, 2013

(30) Foreign Application Priority Data
Mar. 8, 2012 (KR) 10-2012-0023948

(51) Int. Cl. G06F 12/02

(52) U.S. Cl. CPC G06F 12/0246
USPC 711/103

(57) ABSTRACT

A data access memory includes a nonvolatile memory module configured to store meta data and a volatile memory module configured to store normal data. The volatile memory module includes a latency controller delaying input of an address signal and the normal data for a constant delay time to share with the nonvolatile memory module a first transmission line for communicating with a processor.

### CROSS-REFERENCE TO RELATED APPLICATIONS

This US non-provisional patent application claims priority under 35 USC §119 to Korean Patent Application No. 10-2012-0023948, filed on Mar. 8, 2012, the entirety of which is hereby incorporated by reference.

### BACKGROUND OF THE INVENTION

The present general inventive concept relates to data processing apparatuses and, more particularly, to data access memories and methods for preventing data loss of the same when a power supply is interrupted.

A semiconductor memory device is a memory device which is capable of storing data therein and reading the stored data, if necessary. Semiconductor memory devices may be classified into random access memories (RAMs) and read only memories (ROMs). A RAM is a volatile memory which loses its stored data when its power supply is interrupted, while a ROM is a nonvolatile memory which retains its stored data even when its power supply is interrupted. RAMs include a dynamic RAM (DRAM) and a static RAM (SRAM). ROMs include a programmable ROM (PROM), an erasable PROM (EPROM), an electrically EPROM (EEPROM), and a flash memory device.

A data processing device (e.g., computer) uses a volatile memory module (e.g., DRAM module), among semiconductor memory devices, for high-speed data access. A DRAM module is a type of RAM and stores respective bits constituting information in separate capacitors. Each bit has a value of “0” or “1” depending on the charge stored in each capacitor. A DRAM module reproduces the content of a memory device at regular intervals to prevent leakage of electrons in a capacitor. When a power supply of a nonvolatile memory module such as a DRAM module is interrupted, information stored before the interruption of the power supply is erased. When a power supply of a volatile memory module is interrupted, it is difficult to recover information of the volatile memory module.

### SUMMARY OF THE INVENTION

Embodiments of the inventive concept provide a data access memory and a method for preventing data loss of the data access memory.

An aspect of the inventive concept provides a data access memory. The data access memory may include a nonvolatile memory module configured to store meta data; and a volatile memory module configured to store normal data. The volatile memory module includes a latency controller delaying input of an address signal and the normal data for a constant delay time to share with the nonvolatile memory module a first transmission line for communicating with a processor

In an example embodiment, the volatile memory module may include a plurality of dynamic random access memories.

In an example embodiment, the latency controller may be included between the respective dynamic random access memories.

In an example embodiment, the latency controller may include an address latency controller delaying the input of the address signal to guarantee RAS# to CAS# delay time of the volatile memory module during an operation of reading data.

In an example embodiment, the latency controller may include a data latency controller delaying the input of the address signal to guarantee RAS# to CAS# delay time of the volatile memory module and delaying the input of the normal data to guarantee clock write latency time of the volatile memory module during an operation of writing data.

In an example embodiment, the nonvolatile memory module may include at least one of a magnetic random access memory and a plurality of spin transfer torque magnetic random access memories.

In an example embodiment, the data access memory is configured to communicate at least the normal data between an external data storage device and the processor.

In an example embodiment, the meta data may be mapping data for mapping a logical address of the processor and a physical address of the external data storage device.

In an example embodiment, the latency controller delays input of the address signal and the normal data for the constant delay time to also share with the nonvolatile memory module a second transmission line for communicating with the processor, wherein the first transmission line is a data transmission line along which is the normal data and the meta data are transmitted, and the second transmission line is a control signal transmission line along which the address signal and a command signal are transmitted.

Another aspect of the inventive concept provides a data processing method of a data access memory. The data processing method may include receiving at the data access memory data divided into meta data and normal data; storing the meta data in a nonvolatile memory module of the data access memory; and delaying input of an input address signal and the normal data for a constant delay time when the normal data is stored in a volatile memory module of the data access memory.

In an example embodiment, a transmission line receiving at least one of the meta data and normal data, an address signal, and a command signal with an external processor may be shared between the volatile memory module and the nonvolatile memory module.

In an example embodiment, the delaying of the input may include delaying input of the address signal to guarantee RAS# to CAS# delay time of the volatile memory module during an operation of reading data.

In an example embodiment, the delaying of the input may include delaying input of the address signal to guarantee RAS# to CAS# delay time of the volatile memory module and delaying input of the normal data to guarantee clock write latency time of the volatile memory module during an operation of writing data

In an example embodiment, the volatile memory module may include a plurality of dynamic random access memories.

In an example embodiment, the nonvolatile memory module may include at least one of a magnetic random access memory and a plurality of spin transfer torque magnetic random access memories.

Another aspect of the invention provides an apparatus including a data access memory. The data access memory comprises: a nonvolatile memory module comprising at least one nonvolatile memory device configured to store normal data therein; a volatile memory module comprising a latency controller and at least one nonvolatile memory device configured to store meta data therein; a data pin; a control signal pin; first internal transmission lines internal to the data access memory, connecting the data pin and the control signal pin respectively to the nonvolatile memory module; and second internal transmission lines internal to the data access memory, connecting the data pin and the control signal pin respectively to the volatile memory module. The latency controller is configured to delay the normal data received via the data pin by a first delay, and to delay an address received via the control signal pin by a second delay, so as to compensate for a difference in protocol between the nonvolatile memory module and the volatile memory module.

In an example embodiment, the apparatus further includes a buffer configured to receive the address from the control signal pin and to output the address to one of the first internal transmission lines and to further output the address to one of the second internal transmission lines.

In an example embodiment, the buffer is further configured to buffer the normal data and the meta data when it is communicated with the data pin.

In an example embodiment, the apparatus further comprises: a processor; a data transmission line connected to the data pin, and along which the normal data and the meta data are communicated between the processor and the data access memory; a control signal transmission line connected to the control signal pin, and along which the address signal and a command signal are communicated between the processor and the data access memory.

In an example embodiment, the apparatus further comprise a data storage unit comprising at least one of a hard disk drive and a solid-state drive, and wherein the data access memory communicates the normal data and the meta data with the data storage unit under control of the processor.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 illustrates an example of a data processing device according to the inventive concept.

FIG. 2A illustrates an example embodiment of a data access memory according to the inventive concept.

FIG. 2B illustrates another example embodiment of a data access memory according to the inventive concept.

FIG. 3A illustrates an example embodiment of a data access memory including a buffer according to the inventive concept.

FIG. 3B illustrates another example embodiment of a data access memory including a buffer according to the inventive concept.

FIG. 4 illustrates an example embodiment of a structure of a dynamic random access memory (DRAM) including a latency controller according to the inventive concept.

FIG. 5 is a timing diagram illustrating an example of a read operation of an example embodiment of a data processing device according to the inventive concept.

FIG. 6 is a clock timing diagram illustrating an example of a write operation of an example embodiment of a data processing device according to the inventive concept.

### DETAILED DESCRIPTION

The inventive concept will now be described more fully hereinafter with reference to the accompanying drawings, in which preferred embodiments of the inventive concept are shown.

In embodiments of the inventive concept, a data access memory is a memory accessed by a processor a similar controller and means a set of volatile and/or nonvolatile memory chips mounted on a substrate.

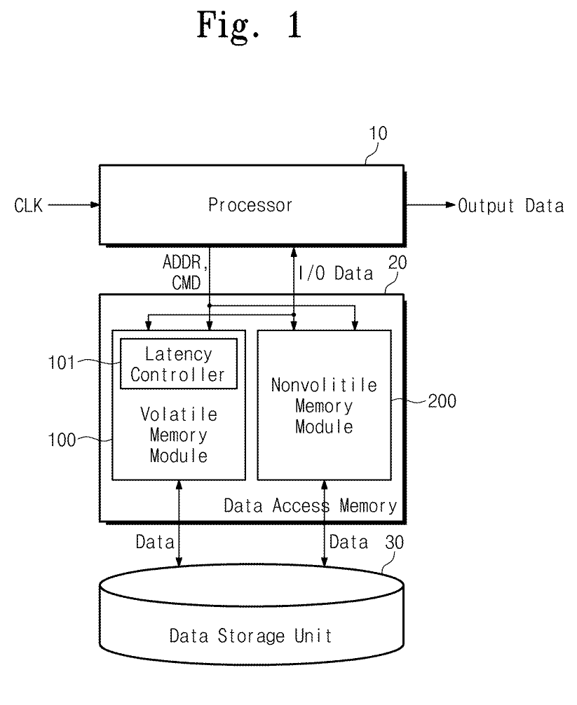

Reference is made to FIG. 1, which illustrates an example of a data processing device according to the inventive concept. The data processing device includes a processor 10, a data access memory 20, and a data storage unit 30.

Processor 10 may be connected to data access memory 20 and may write/read data to/from data storage unit 30 through data access memory 20. Processor 10 outputs a control signal, an address signal ADDR, and a command signal CMD to data access memory 20 to read or write data. Processor 10 may provide input data to data access memory 20 and receive output data from data access memory 20. Processor 10 may directly output the output data to an external destination, or may output the output data through an output device (not shown).

Processor 10 may distinguish important data, e.g., meta data (or mapping data) among data to be output to data access memory 20 from normal data. The meta data is data for mapping between a logical address of processor 10 and a physical address of data storage unit 30. The meta data also may be “hot data,” which indicates properties of a file.

Data access memory 20 is disposed functionally between processor 10 and data storage unit 30 and accesses data storage unit 30 under the control of processor 10. Thus, processor 10 may read and write data from and to data storage unit 30 through data access memory 20. Data access memory 20 stores data such that the data may be immediately accessed by processor 10.

Data access memory 20 may include, e.g., a dynamic random access memory (DRAM) or a static random access memory (SRAM) and a nonvolatile memory or the like. In particular, data access memory 20 may include a volatile memory module 100 and a nonvolatile memory module 200. Nonvolatile memory module 200 may include, e.g., a magnetic RAM (MRAM). The meta data which is distinguished or identified by processor 10 from normal data is important data or high priority data, compared to the normal data, and which should not be lost when a power supply is interrupted. Nonvolatile memory module 200 retains its stored data even when its power supply is interrupted. Accordingly, data access memory 20 stores the meta data distinguished or identified by processor 10 in nonvolatile memory module 200. Normal data, which are less important or lower priority than the meta data, are stored in volatile memory module 100.

Data access memory 20 is connected to processor 10 through a transmission line arrangement. In the data processing device of FIG. 1, the transmission line arrangement includes a first transmission line as a data transmission line along which data DATA is transmitted, and a second transmission line as a control signal transmission line along which an address signal ADDR and a command signal CMD are transmitted.

Since there is a difference in protocol between volatile memory module 100 and nonvolatile memory module 200, if they were connected to the transmission line(s) without any other provision, they could not share the same transmission line(s). Accordingly, to allow volatile memory module 100 and nonvolatile memory module 20 to share the same transmission line(s), volatile memory module 100 may include a latency controller 101 to guarantee an address signal input latency required by the difference in protocol between volatile memory module 100 and nonvolatile memory module 200 during a read operation and a write operation, and data output latency caused by the difference during a write operation. Thus, volatile memory module 100 and nonvolatile memory module 200 of data access memory 20 may share the same transmission line(s) for communicating with processor 10.

For convenience of description, shown is a structure in which the data access memory 20 includes volatile memory module 100 and nonvolatile memory module 200. In this structure, volatile memory module 100 may include a plurality of volatile memories and nonvolatile memory module 200 may include at least one nonvolatile memory. Each of the volatile memories included in volatile memory module 100 may include a corresponding latency controller 101.

Data storage unit 30 may store data, especially a large amount of data therein. Data storage unit 30 is disposed external to data access memory 20. Therefore, data storage unit 30 is connected to data access memory 20. Data storage unit 30 stores data input from data access memory 20 and outputs stored data to data access memory 20.

Data access memory 20 may lose at least some of its stored data when its power supply is interrupted. In the data processing device of FIG. 1, data access memory 20 is a type of complex memory including volatile memory module 100 and nonvolatile memory module 200 which may prevent at least some data loss caused by interruption of a power supply. Thus, the data processing device may minimize an affect of the data loss caused by the interruption of a power supply by storing important or high priority data such as meta data in nonvolatile memory module 200.

Moreover, in the data processing device of FIG. 1, volatile memory module 100 includes a latency controller 101 for guaranteeing an operating speed required by a difference in protocol between volatile memory module 100 and nonvolatile memory module 200. Thus, the data processing device may employ a single transmission line (or transmission pin), or a single pair of transmission lines (or transmission pins), without use of separately distinguished transmission lines between processor 10 and data access memory 20 for the normal data and the meta data.

In a case where the data processing device is, e.g., a computer, processor 10 corresponds to a central processing unit (CPU), data access memory 20 corresponds to a main memory, and data storage unit 30 corresponds to an auxiliary memory. Hence, processor 10 may include a CPU, a graphic processing unit (GPU), etc. Data access memory 20 may include a DRAM, etc. Data storage unit 30 may include a hard disk drive (HDD), a solid-state drive (SSD), etc.

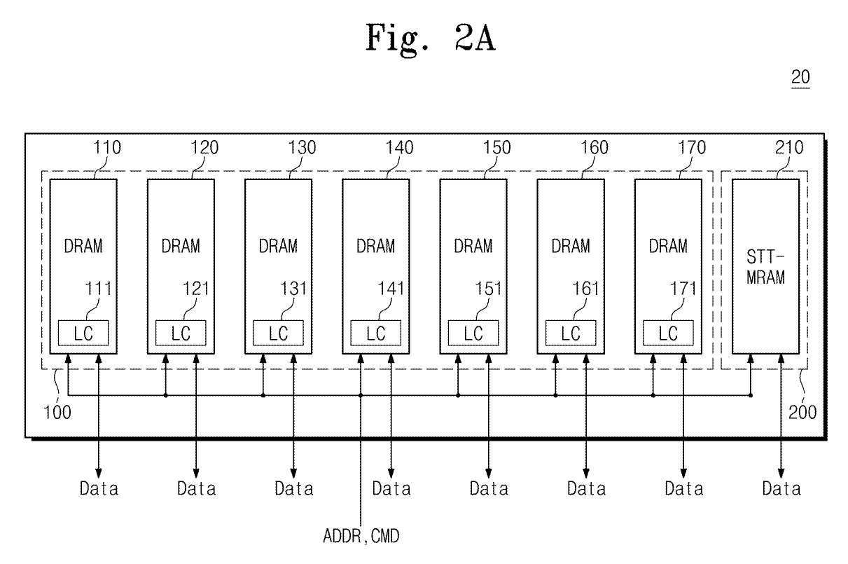

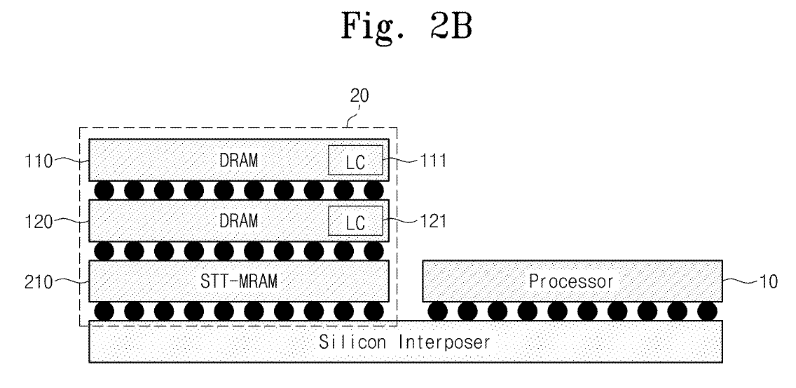

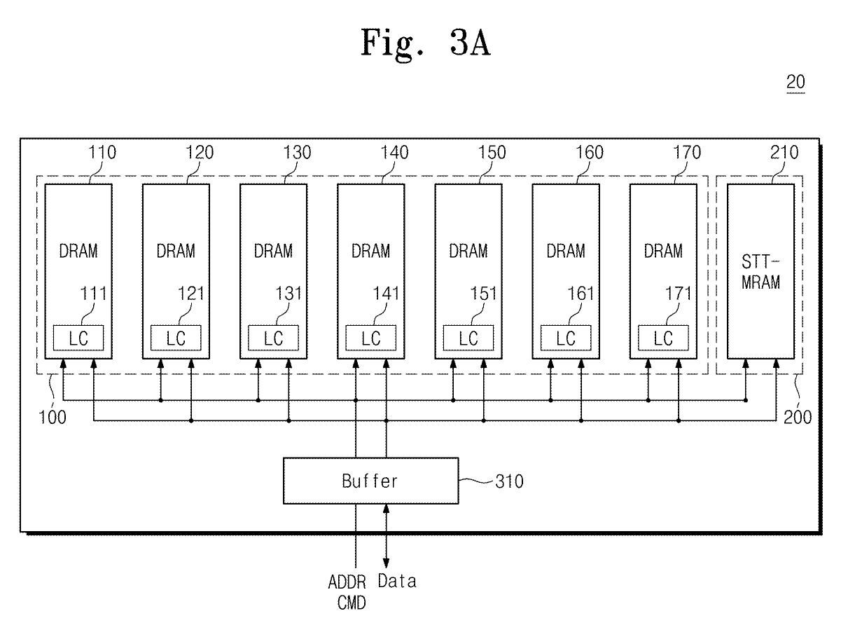

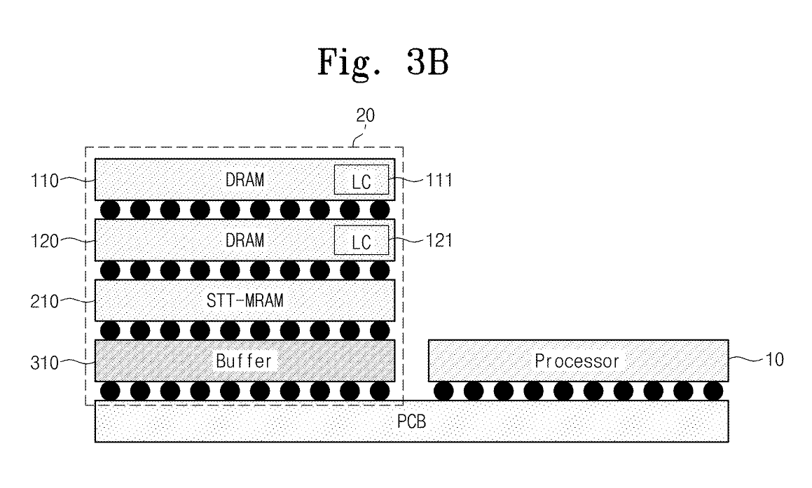

FIGS. 2A to 3B illustrate example memory structures to which a data access memory according to the inventive concept may be applied. In FIGS. 2A to 3B, a volatile memory module 100 is, e.g., a dynamic random access memory (DRAM) and a nonvolatile memory module 200 is, e.g., a magnetic random access memory (MRAM).

Reference is now made to FIG. 2A, which illustrates an example embodiment of data access memory 20. Data access memory 20 of FIG. 2A includes volatile memory module 100 and nonvolatile memory module 200. Volatile memory module 100 includes a plurality of dynamic random access memories (DRAMs) 110, 120, 130, 140, 150, 160, and 170. Nonvolatile memory module 200 includes a magnetic random access memory (MRAM) 210.

Each of DRAMs 110, 120, 130, 140, 150, 160, and 170 stores normal data therein.

MRAM 210 stores meta data therein. MRAM 210 may be implemented as, e.g., a spin transfer torque MRAM (STT-MRAM). The embodiment of nonvolatile memory module 200 shown in FIG. 2A includes one MRAM 210. In other embodiments, nonvolatile memory module 200 may include two or more MRAMs. Although it is shown in FIG. 2 that MRAM 210 is disposed at one side of DRAMs 110, 120, 130, 140, 150, 160, and 170, MRAM 210 may be disposed between respective DRAMs 110, 120, 130, 140, 150, 160, and 170.

DRAMs 110, 120, 130, 140, 150, 160, and 170 include latency controllers 111, 121, 131, 141, 151, 161, and 171, respectively. Latency controllers 111, 121, 131, 141, 151, 161, and 171 guarantee an operating speed required by a difference in protocol from the protocol of MRAM 210 during a write operation and a read operation. Thus, DRAMs 110, 120, 130, 140, 150, 160, and 170 and MRAM(s) 210 may mutually input/output data through the same data transmission line and mutually receive an address signal and a command signal through the same control signal transmission line.

Reference is now made to FIG. 2B, which illustrates another example embodiment of data access memory 20. Data access memory 20 of FIG. 2B includes a plurality of dynamic random access memories (DRAMs) 110 and 120 and a magnetic random access memory (MRAM) 210. DRAMs 110 and 120 comprise a nonvolatile memory module, and the MRAM 210 is a volatile memory module.

Except that DRAMs 110 and 120 and MRAM 210 are stacked, data access memory 20 in FIG. 2B has a similar structure to data access memory 20 in FIG. 2A. Therefore, the detailed description of DRAMs 110 and 120 and MRAM 120 will be provided with reference to FIG. 2A.

Data access memory 20 may have a stacked-type structure and be connected to processor 10 through a silicon interposer.

First DRAM 110 includes latency controller 111 therein, and second DRAM 120 includes a latency controller 121 therein. Latency controllers 111 and 121 guarantee an operating speed required by a difference in protocol from the protocol of MRAM 210 during a write operation and a read operation. Thus, DRAMs 110 and 120 and MRAMs 210 may mutually input/output data through the same data transmission line, and mutually receive an address signal and a command signal through the same control signal transmission line.

Reference is now made to FIG. 3A, which shows an example embodiment of a data access memory 20 including a buffer according to the inventive concept. Data access memory 20 includes volatile memory module 100, nonvolatile memory module 200, and buffer 310. Volatile memory module 100 includes a plurality of dynamic random access memories (DRAMs) 110, 120, 130, 140, 150, 160, and 170. Nonvolatile memory module 200 includes a magnetic random access memory (MRAM) 210.

Each of DRAMs 110, 120, 130, 140, 150, 160, and 170 stores normal data therein.

MRAM 210 stores meta data therein. MRAM 210 may be implemented as, e.g., a spin transfer torque MRAM (STT-MRAM). The embodiment of nonvolatile memory module 200 shown in FIG. 3A includes one MRAM 210. However in other embodiments, nonvolatile memory module 200 may include two or more MRAMs. Although it is shown in FIG. 3A that the MRAM 210 is disposed at one side of DRAMs 110, 120, 130, 140, 150, 160, and 170, MRAM 210 may be disposed between respective DRAMs 110, 120, 130, 140, 150, 160, and 170.

Buffer 310 may temporarily store control signals ADDR and CMD input to DRAMs 110, 120, 130, 140, 150, 160, and 170 and MRAM 210, and data DATA input/output thereto.

DRAMs 110, 120, 130, 140, 150, 160, and 170 include latency controllers 111, 121, 131, 141, 151, 161, and 171, respectively. Latency controllers 111, 121, 131, 141, 151, 161, and 171 guarantee an operating speed caused by a difference in protocol from the protocol of the MRAM 210 during a write operation and a read operation. Thus, DRAMs 110, 120, 130, 140, 150, 160, and 170 and MRAM(s) 210 may mutually input/output data through the same data transmission line, and mutually receive an address signal and a command signal through the same control signal transmission line.

Reference is now made to FIG. 3B, which illustrates another data access memory 20 including a buffer. Data access memory 20 includes a plurality of dynamic random access memories (DRAMs) 110 and 120, magnetic random access memory (MRAM) 210, and buffer 310. DRAMs 110 and 120 are a volatile memory module, and MRAM 210 is a nonvolatile memory module.

Except that DRAMs 110 and 120 and MRAM 210 are stacked, data access memory 20 in FIG. 3B has a similar structure to data access 20 in FIG. 3A. Therefore, the detailed description of DRAMs 110 and 120, MRAM 120, and buffer 310 will be provided with reference to FIG. 3A.

Data access memory 20 may have a stacked-type structure and be connected to processor 10 through a printed circuit board (PCB).

First DRAM 110 includes latency controller 111 therein, and second DRAM 120 includes latency controller 121 therein. Latency controllers 111 and 121 guarantee an operating speed required by a difference in protocol from the protocol of MRAM 210 during a write operation and a read operation. Thus, DRAMs 110 and 120 and MRAMs 210 may mutually input/output data through the same data transmission line, and mutually receive an address signal and a command signal through the same control signal transmission line.

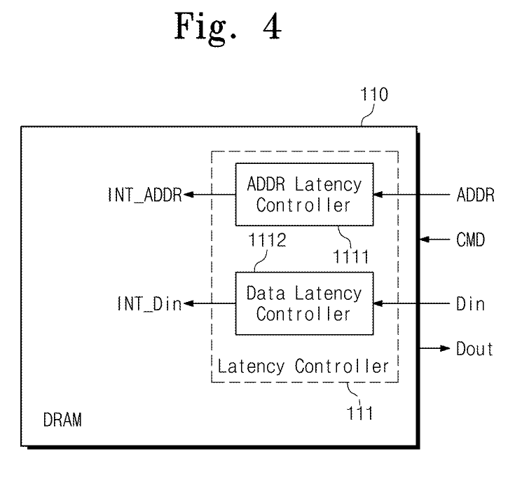

Reference is now made to FIG. 4, which illustrates an example embodiment of dynamic random access memory (DRAM) 110 including latency controller 111, which in turn includes an address latency controller 1111 and a data latency controller 1112.

Address latency controller 1111 delays an input address signal ADDR to generate an internal address signal INT_ADDR. In some embodiments controller 1111 delays the address signal ADDR by an RAS# to CAS# delay time (tRCD). RAS# is a row address strobe, and CAS# is a column address strobe. That is, a row is searched before a column is searched in DRAM 110. The RAS# to CAS# delay time (tRCD) is the number of clock cycles between selecting a row with a row address strobe RAS# and selecting a column with a column address strobe CAS#. The address latency controller 1111 outputs the internal address signal INT_ADDR into DRAM 110.

Data latency controller 1112 delays input data Din to generate internal data signal INT_Din. Data latency controller 1112 delays the data Din by CAS Write Latency (CWL) time of DRAM 110. Data latency controller 1112 outputs the internal data INT_Din into DRAM 110.

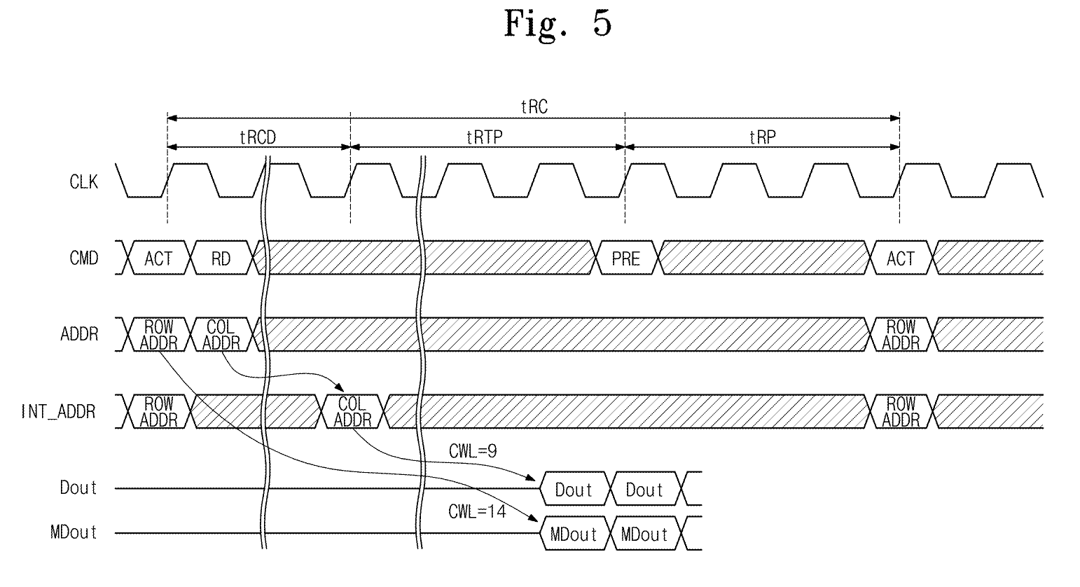

Reference is now made to FIG. 5, which is a clock timing diagram illustrating an example of a read operation of an example embodiment of a data processing device according to the inventive concept.

As shown in FIG. 5, one read cycle time (tRC) includes RAS# to CAS# delay time (tRCD), read to precharge time (tRTP), and row precharge time (tRP).

Processor 10 receives a clock signal CLK and operates in synchronization with the clock signal CLK. Processor 10 generates a command signal CMD and an address signal ADDR based on the clock signal CLK. Processor 10 outputs the command signal CMD and the address signal ADDR to data access memory 20 for a read operation.

Data access memory 20 receives the command signal CMD and the address signal ADDR at a control signal pin, via a shared control signal transmission line. Data access memory 20 outputs the command signal CMD and the address signal ADDR to volatile memory module 100 and nonvolatile memory module 200 through respective first and second internal transmission lines which are internal to data access memory 20 and which have the same characteristics as each other.

The command signal CMD includes an enable signal ACT, a read signal RD, and a precharge signal PRE. The address signal ADDR includes a row address signal ROW ADDR and a column address signal COL ADDR. A magnetic random access memory (MRAM) 200 may perform a read operation using the row address signal ROW ADDR and the column address signal COL ADDR that are successively or consecutively input with the column address signal COL ADDR immediately following the row address signal ROW ADDR. However, volatile memory module 100 is required to guarantee a certain delay time (tRCD) between RAS# and CAS#. Accordingly, volatile memory module 100 performs a read operation using an internal address signal INT_ADDR by delaying the column address signal COL ADDR through latency controller 111 to guarantee the required RAS# to CAS# delay time (tRCD) between the row address signal ROW ADDR and the column address signal COL ADDR that are successively input.

In FIG. 5, there are shown output normal data Dout of a DRAM and meta data MDout of an MRAM that are output from a data pin of data access memory 20 onto a shared data transmission line by such a read operation.

The RAM internally delays an address signal to compensate RAS# to CAS# delay time (tRCD) during a read operation. Thus, the DRAM may use an internal transmission line after the internal transmission line branches to correspond to the number of pins having the same number as volatile memory modules 100.

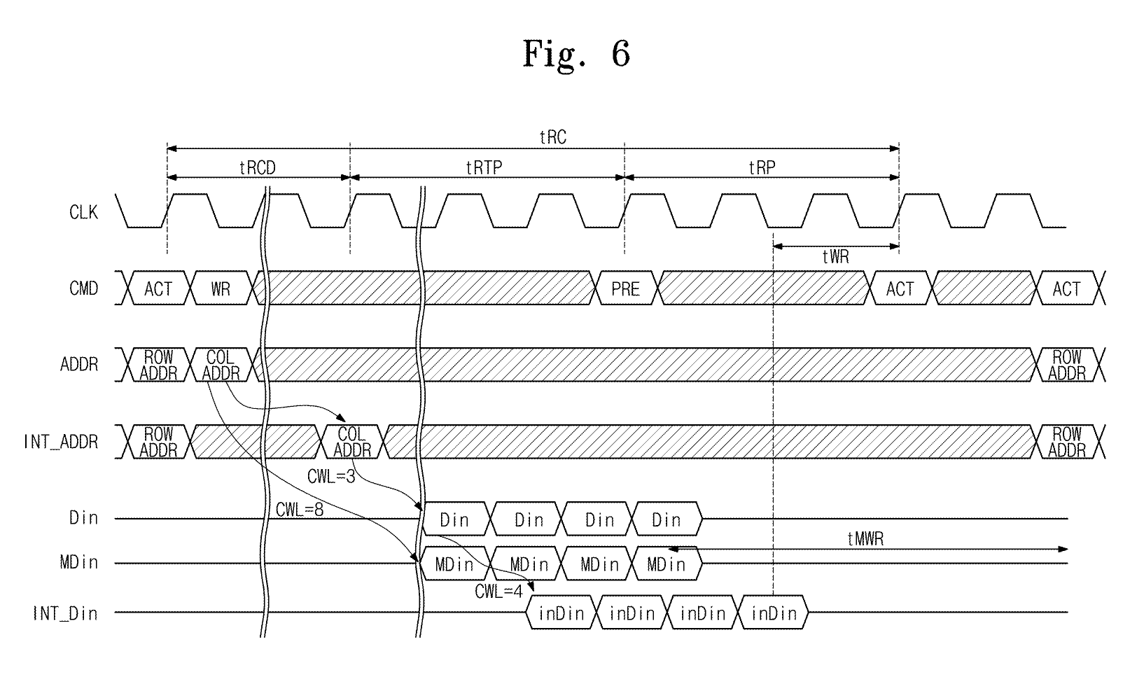

Reference is now made to FIG. 6, which is a clock timing diagram illustrating a write operation of a data processing device according to the inventive concept.

As shown in FIG. 6, one row cycle time (tRC) includes RAS# to CAS# delay time (tRCD), read to precharge time (tRTP), and row precharge time (tRP).

Processor 10 receives a clock signal CLK and operates in synchronization with the clock signal CLK. Processor 10 generates a command signal CMD and an address signal ADDR based on the clock signal CLK. Processor 10 outputs the command signal CMD and the address signal ADDR to data access memory 20 for a write operation.

Data access memory 20 receives the command signal CMD and the address signal ADDR at a control signal pin, via the control signal transmission line. Data access memory 20 outputs the command signal CMD and the address signal ADDR to volatile memory module 100 and nonvolatile memory module 200 through respective first and second internal transmission lines internal to data access memory 20 and having the same characteristics as each other.

The command signal CMD includes an enable signal ACT, a write signal WR, and a precharge signal PRE. The address signal ADDR includes a row address signal ROW ADDR and a column address signal COL ADDR. Magnetic random access memory (MRAM) 200 may perform a write operation using the row address signal ROW ADDR and the column address signal COL ADDR that are successively input. Volatile memory module 100 is required to guarantee the required RAS# to CAS# delay time (tRCD). Accordingly, nonvolatile module 100 performs a write operation using an internal address signal INT_ADDR by delaying the column address signal COL ADDR through latency controller 111 to guarantee the RAS# to CAS# delay time (tRCD) between the row address signal ROW ADDR and the column address signal COL ADDR that are successively input one immediately after the other.

Data Din and data MDin are simultaneously input to volatile memory module 100 and nonvolatile memory module 200, respectively. However, a DRAM is required to guarantee a latency time by an internally predetermined CAS Write Latency (CWL) time. The CWL is the delay, in clock cycles, between the internal Write command and the availability of the first bit of input data (for example, Din). The CWLtime is about 5-12 according to the frequency. For example, the CWL time during a write operation of volatile memory module 100 may have a value of about 7(CWL) on the basis of the point of time when tRCD is terminated. At this point, since CWL input to volatile memory module 100 is about 3(CWL), volatile memory module 100 performs a write operation using internal input data INT_Din delayed by internal input latency time ‘about 4’ through latency controller 111 incorporated therein. The internal input latency time is a time difference between first data of Din and first data of INT_Din.

DRAM 200 internally delays an address signal to guarantee a required RAS# to CAS# delay time (tRCD) during a write operation and outputs data to guarantee clock write latency time of a write operation.

A data access memory of a data processing device as described above includes at least one nonvolatile memory, e.g., a magnetic random access memory (MRAM) between nonvolatile memories, e.g., a plurality of dynamic random access memories (DRAMs). The data processing device stores main or meta data of the data access memory in a nonvolatile memory, e.g., an MRAM, to prevent data loss when its power supply is interrupted.

Particularly, a volatile memory includes a latency controller to guarantee a processing speed which is compatible with a nonvolatile memory. The latency controller allows the volatile memory to share the same transmission line(s) to a processor with the nonvolatile memory for transmitting a command signal CMD and data DATA. Thus, the data access memory may share a transmission line(s) to a processor irrespective of protocol without use of separate individual transmission lines for the nonvolatile memory and the volatile memory.

The proposed data processing device may be applied to, e.g., computers, laptop computers, workstations, servers, etc.

According to the inventive concept described so far, a nonvolatile memory is disposed between a plurality of volatile memories and main data is stored in the nonvolatile memory to prevent data loss even when a power supply is abruptly interrupted. In addition, the volatile memory includes a latency controller which adjusts processing speed between the volatile memory and the nonvolatile memory having different protocols to share a transmission line(s) along which a command signal, an address signal, and data are transmitted between the volatile memory and the nonvolatile memory.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A data access memory, comprising:
a nonvolatile memory module configured to store meta data; and
a volatile memory module configured to store normal data,
wherein the volatile memory module includes a latency controller delaying input of an address signal and the normal data for a constant delay time to share with the nonvolatile memory module a first transmission line for communicating with a processor.

2. The data access memory as set forth in claim 1, wherein the volatile memory module includes a plurality of dynamic random access memories.

3. The data access memory as set forth in claim 2, wherein the latency controller is included between the respective dynamic random access memories.

4. The data access memory as set forth in claim 3, wherein the latency controller includes an address latency controller delaying the input of the address signal to guarantee RAS# to CAS# delay time of the volatile memory module during an operation of reading data.

5. The data access memory as set forth in claim 3, wherein the latency controller includes a data latency controller delaying the input of the address signal to guarantee RAS# to CAS# delay time of the volatile memory module, and delaying the input of the normal data to guarantee a clock write latency time of the volatile memory module during an operation of writing data.

6. The data access memory as set forth in claim 1, wherein the nonvolatile memory module includes at least one of a magnetic random access memory and a plurality of spin transfer torque magnetic random access memories.

7. The data access memory as set forth in claim 3, wherein the data access memory is configured to communicate at least the normal data between an external data storage device and the processor.

8. The data access memory as set forth in claim 7, wherein the meta data is mapping data for mapping a logical address of the processor and a physical address of the external data storage device.

9. The data access memory as set forth in claim 1, wherein the latency controller delays input of the address signal and the normal data for the constant delay time to also share with the nonvolatile memory module a second transmission line for communicating with the processor, where the first transmission line is a data transmission line along which the normal data and the meta data are transmitted, and the second transmission line is a control signal transmission line along which the address signal and a command signal are transmitted.

10. A data processing method of a data access memory, comprising:
receiving at the data access memory data divided into meta data and normal data;
storing the meta data in a nonvolatile memory module of the data access memory; and
delaying input of an input address signal and the normal data for a constant delay time when the normal data is stored in a volatile memory module of the data access memory.

11. The data process method as set forth in claim 10, wherein a transmission line receiving at least one of the meta data and normal data, an address signal, and a command signal with an external processor is shared between the volatile memory module and the nonvolatile memory module.

12. The data process method as set forth in claim 10, wherein the delaying of the input comprises:
delaying input of the address signal to guarantee RAS# to CAS# delay time of the volatile memory module during an operation of reading data.

13. The data process method as set forth in claim 10, wherein the delaying of the input comprises:
delaying input of the address signal to guarantee RAS# to CAS# delay time of the volatile memory module, and delaying input of the normal data, to guarantee a clock write latency time of the volatile memory module during an operation of writing data.

14. The data process method as set forth in claim 10, wherein the volatile memory module includes a plurality of dynamic random access memories.

15. The data process method as set forth in claim 10, wherein the nonvolatile memory module includes at least one of a magnetic random access memory and a plurality of spin transfer torque magnetic random access memories.

16. An apparatus including a data access memory, the data access memory comprising:
a nonvolatile memory module comprising at least one nonvolatile memory device configured to store normal data therein;
a volatile memory module comprising a latency controller and at least one nonvolatile memory device configured to store meta data therein;
a data pin;
a control signal pin;
first internal transmission lines internal to the data access memory, connecting the data pin and the control signal pin respectively to the nonvolatile memory module; and
second internal transmission lines internal to the data access memory, connecting the data pin and the control signal pin respectively to the volatile memory module,
wherein the latency controller is configured to delay the normal data received via the data pin by a first delay, and to delay an address received via the control signal pin by a second delay, so as to compensate for a difference in protocol between the nonvolatile memory module and the volatile memory module.

17. The apparatus of claim 16, further including a buffer configured to receive the address from the control signal pin and to output the address to one of the first internal transmission lines and to further output the address to one of the second internal transmission lines.

18. The apparatus of claim 17, wherein the buffer is further configured to buffer the normal data and the meta data when it is communicated with the data pin.

19. The apparatus of claim 17, further comprising:
a processor;
a data transmission line connected to the data pin, and along which the normal data and the meta data are communicated between the processor and the data access memory; and
a control signal transmission line connected to the control signal pin, and along which the address signal and a command signal are communicated between the processor and the data access memory.

20. The apparatus of claim 19, further comprising a data storage unit comprising at least one of a hard disk drive and a solid-state drive, and wherein the data access memory communicates the normal data and the meta data with the data storage unit under control of the processor.
